(19) United States
(12) Patent Application Publication
(10) Pub. No.: US 2002/0038261 A1
(43) Pub. Date: Mar. 28, 2002

(54) System for placing orders through the internet to a selected store of a chain of stores

(76) Inventors: James Kargman, Chicago, IL (US); Marc Asher, Highland Park, IL (US); David Brown, Orange, TX (US); William Pallett, Brandon Hill (GB)

Correspondence Address: LAW OFFICES OF DICK & HARRIS, Suite 3800, 181 W. Madison Street, Chicago, IL, 60602, US

(21) Appl. No.: 09/997,578

(22) Filed: Nov. 29, 2001

Related U.S. Application Data
(63) Continuation of application No. 09/276,252, filed on Mar. 25, 1999.

(51) Int. Cl. G06F 17/60

(52) U.S. Cl. 705/26

(57) ABSTRACT

Internet service that links a plurality of stores of a chain of restaurants together on the Internet at a central server website, whereby the Internet service is based upon postal address alone, and where the software at the web site determines the store closest to the calling customer on the Internet strictly by both postal address which corresponds to the same type of postal-address driven system employed at each store serviced by the system of the invention. The customer order is input directly into the computerized ordering system of the closest, selected store, thereby bypassing the conventional manner of ordering through a live order-taker. The system of the invention is directly linked to the computers of the restaurants of the chain of restaurants, whereby the menu and pricing of each store may be made uploaded to the web site, and displayed on the Internet server web site.

### BACKGROUND OF THE INVENTION

The present invention is directed to a system for use with the Internet that links a chain of stores to a central server of the Internet by which geographically-dispersed customers may place an order to a selected one of the chain of stores as determined by the system of the invention.

### SUMMARY OF THE INVENTION

It is the primary objective of the present invention to provide in Internet service that links a plurality of stores of a chain of stores or restaurants together on the Internet at a central server web-site, whereby this Internet service is based upon postal address alone.

It is, also, the objective of the present invention to determine the store closest to the calling customer on the Internet strictly by postal address which corresponds to the same type of postal-address driven system employed at each store serviced by the system of the invention.

It is also an objective of the present invention to input a customer order directly into the computerized ordering system of the closest, selected store, thereby bypassing the conventional manner of ordering through a live order-taker, which is extremely labor-intensive and, therefore, costly.

It is an objective of the present invention to directly link the server software of the invention with the software and computer of each local store of a chain of stores or restaurants, whereby, not only are orders directly downloaded to the local store's computer system for storing orders in order to bypass live order-takers, but also provide for the uploading of the local store's menu and pricing, whereby menu and pricing changes may be made and displayed on the Internet server web site substantially immediately after such changes have been decided upon at the local store.

### BRIEF DESCRIPTION OF THE DRAWINGS

The invention will be more readily understood with reference to the accompanying drawings, wherein:

FIG. 1 is a flow chart of the initial entry/user login web ordering process of the present invention;

FIG. 2 is a flow chart showing to address normalization and matching process of the Web ordering process of the invention;

FIG. 3 is a flow chart showing the actual ordering process after user login;

FIG. 4 is a flow chart showing the order transmission process after the order has been taken according to the invention;

FIG. 5 is a flow chart showing the transmission details of the order transmission of the Web ordering process of the present invention.

### DETAILED DESCRIPTION OF THE INVENTION

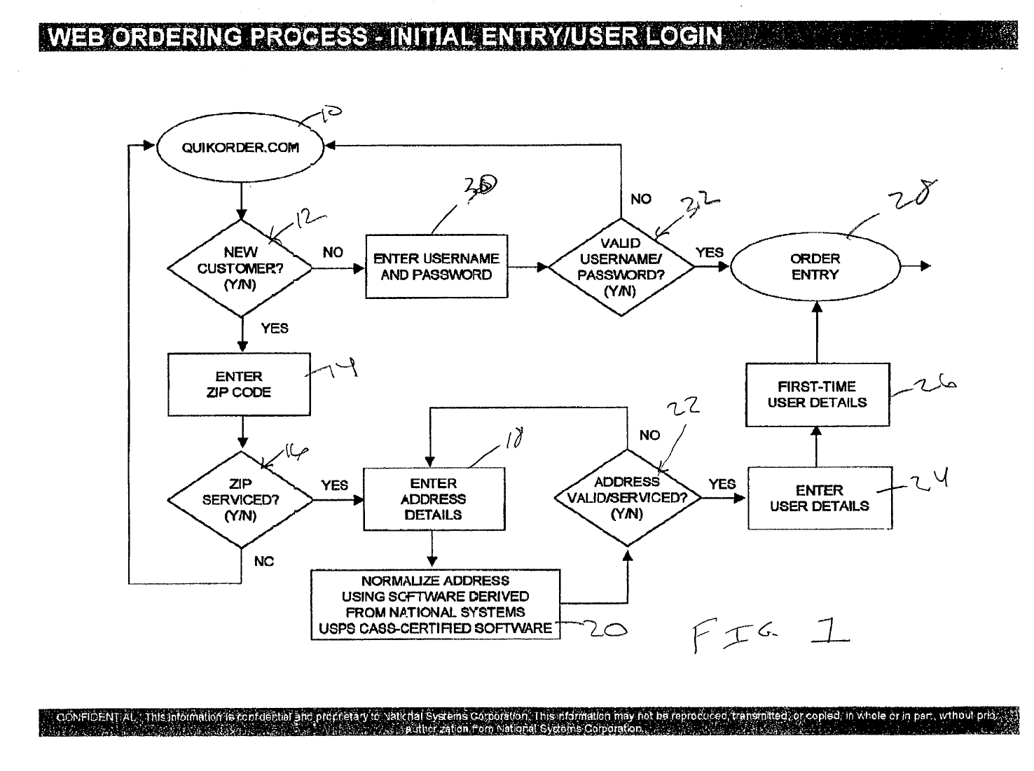

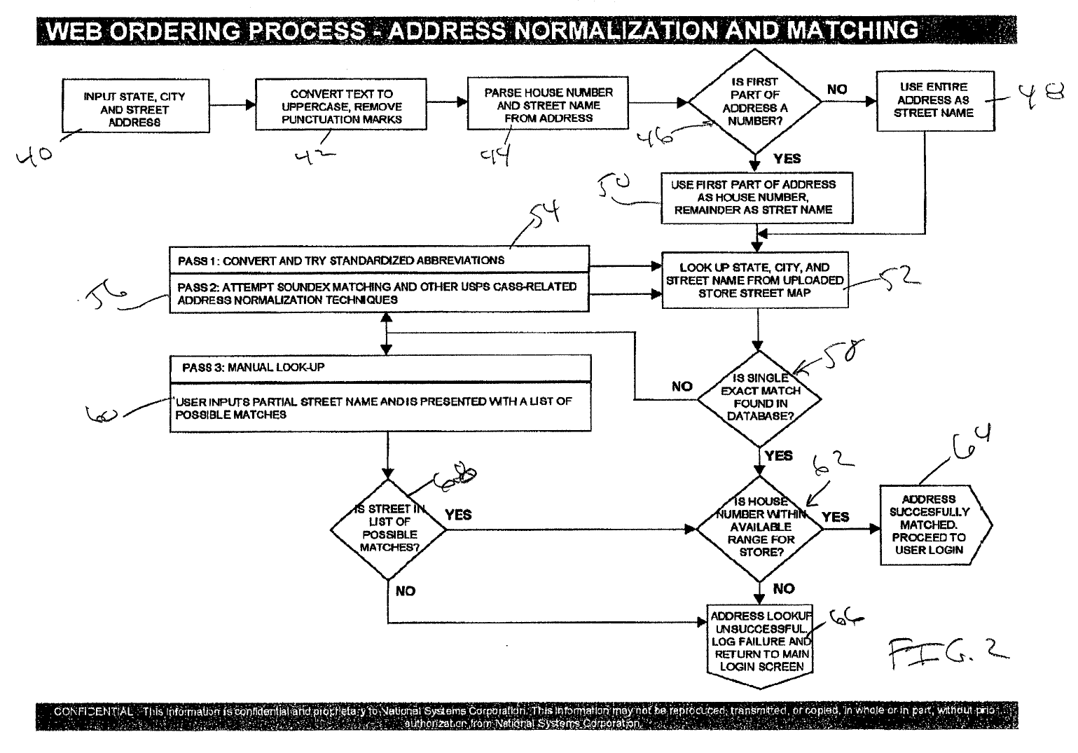

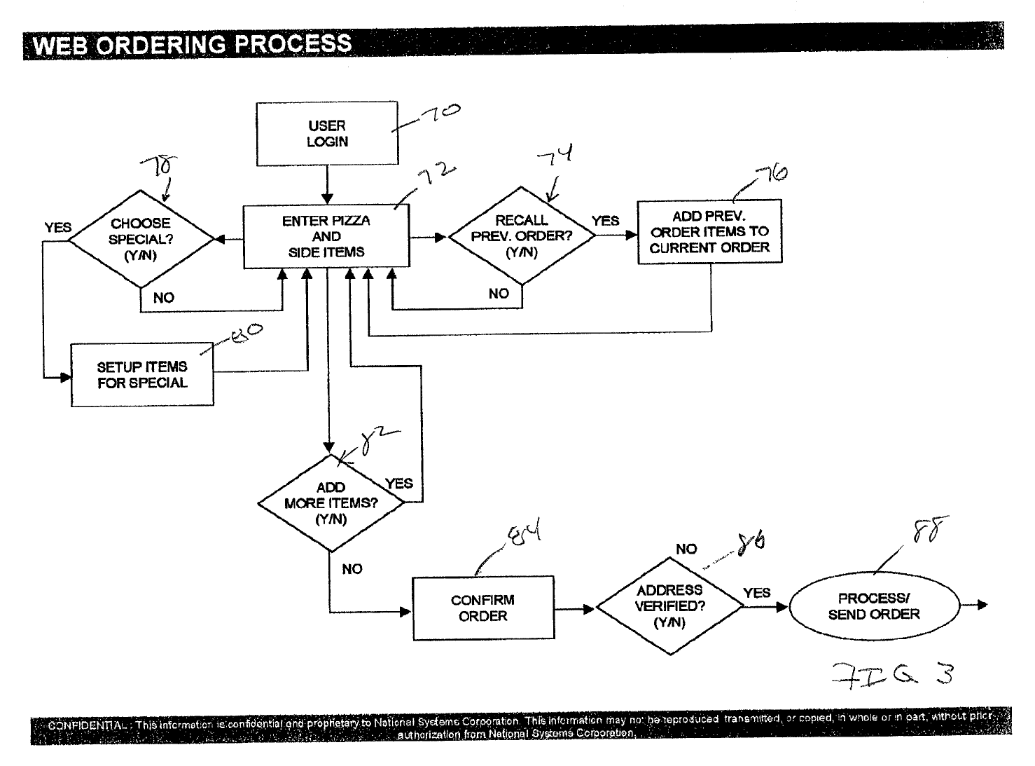

Referring now to the drawings in greater detail, there is shown in FIG. 1 the initial entry and user-login flow chart of the software of the present invention. Initial entry is into the web site, called “quikorder.com” (block 10). The software of the system of the invention then prods the customer to input whether he is a new customer (block 12). If “YES”, then the software will proceed to process the new customer, by asking him to input his postal service zip code (block 14). The software of the invention then determines if that zip code is serviced by a store of the chain of stores or restaurants (block 16). If the answer is “NO”, then the program returns to its starting point and indicates to the new customer that there is no available store or restaurant that services his area. If there is a store that services that zip code of the new customer (“YES” to decision block 16), then the new customer is asked to input his postal address (block 18). After such entry, the system-software of the invention next normalizes the address, which means that the input address is checked and compared against a list of normalized, postal service addresses in order to make sure that the address conforms to standard, USPS-CASS (U.S. Postal Service—Coding Accuracy Support System) addresses (block 20). Such address-normalization software is available from National Systems Corporation of Chicago, Illinois, and is known as “ULTRA TMS” Postal-Pak, which is a U.S. Postal Service, CASS-certified address-matching software. This certified software achieves the standardization of addresses required by the U.S. Postal Service, which includes the standardization of: addresses by city names, street names, post and prefixes, directionals and Puerto Rica urbanizations; city zip codes rationalization; city-alias lookup; address-lookup in USPS country-wide database, including soundex and dropout matching; alias street-name substitution; firm-name lookup for businesses; high-rise office and apartment validation; and postal-delivery, point bar-code generation. This normalization will convert the address input by the new customer into a standard form used by the U.S. Postal Service. Thus, if the customer had input the abbreviation “ST.” instead of “STREET”, the normalization software will convert the abbreviation to its full word, “Street”. The same will hold for other entries made by a new customer. This standardization, or normalization, is performed in order to eliminate errors, whereby deliveries to the wrong address are prevented. FIG. 2 discussed hereinbelow amplifies upon this normalization process. Decision block 22 then determines if the address is a valid and/or serviced address, and, if “NO”, the program will exit or prompt the new customer to enter another address or change the previously input address (block 18). If the answer to decision block 22 is “YES”, then the software of the invention enters all of the details of the new customer (blocks 24 and 26), and then the software proceeds to the “ORDER” process (discussed hereinbelow in greater detail when discussing FIG. 3). The software represented by block 24 stores the address of the new customer , while block 26 prompts the new customer to enter his name and a password that will be used for all subsequent orders.

If the answer to decision block 12 is “NO”, meaning that the customer is not a new customer, then that customer is prompted to enter his name and password (block 30). The software of the system of the invention then verifies the user's name and password (decision block 32). If not verified (“No” to decision block 32), then the software returns to the initial screen with an appropriate error message displayed. If the answer to decision block 32 is “YES”, meaning the user's name and password have been verified, then the software of the invention proceeds to the “ORDER” process, or menu (block 28), discussed hereinbelow with reference to FIG. 3.

Referring now to FIG. 2, the flow chart for the address-normalization of the web-ordering process is shown, which flow chart is a detail of general blocks 20 and 22 of FIG. 1. The address-normalization process starts with the input of the street address with city, state and zip code, which has been input by the new customer (block 40). This input-text is then converted to all uppercase letters, with all punctuation marks removed (block 42). Then, the software of the invention parses the house number and street name from the address (block 44), as discussed above, in order to more easily compare it against a certified, normalized list of postal service addresses. In decision block 46, the software of the invention first determines if the first part of the address is a number. If “NO”, then entire address is used as the street address, meaning no number is associated with the street (block 48). If the address does have a first part that is a number, then the software of the invention will use that number as the house number, and the remainder of that parsed address as the street name (block 50). After the proper street address has been determined, the software of the invention will then look up the entire address, with city state and zip code, on a store street-map of all stores servicing the entered zip code (block 52). This street-map had been previously up-loaded from each of the individual stores to the central server or web site. Each store map defines the geographical boundaries serviced by that particular store, based on postal service address (as discussed above in detail). This look-up, or matching, is done against a normalized address-listing of postal service addresses that is certified by the U.S. Postal Service. The first attempt to match the input address to the certified list is done using standardized abbreviations, such as converting St. for STREET or Ave. for AVENUE, and the like. If a single match then ensues, then that address is used (block 54). It is noted that since the store map is based on postal service addresses, the addresses of the street maps may be updated or corrected by the software of the invention. If step 54 fails, then the software of the invention will then use a more sophisticated USPS, CASS-related address-normalization technique (block 56). This technique is known and has been used for mailing purposes for matching street addresses against the official, U.S. Postal Service address. Decision block 58 checks to see if only a single address-match has been found. If “YES”, then the program proceeds. If “NO”, meaning more than one match was found, then the program will run through steps 54 or 56 again, and if they fail again to derive a single, matched address, then the user is prompted to manually input part of the street name, and then the software of the invention will present a list of possible matches for the user to select (block 60). After the normalized, or standardized, single address has been determined from the store map, either using steps 54 or 56, the answer to decision block 58 will be “YES”, and the program of the invention will proceed to determine if the store services the user. In decision block 62, the software of the invention determines if the house number of the user is serviced by the store. If “YES”, then the user may proceed to log-in and to the order-menu program (block 64), discussed hereinbelow when discussing FIG. 3. If the answer to decision block 62 is “NO”, then the address-lookup process failed, and the program returns to the main login-screen, indicating log-in failure (block 66). If the manual step of block 60 had to be used for determining a match, then decision block 68 of the program of the invention determines if the street manually selected by the user is in the list of possible street matches in the store map servicing area. If “YES”, then the program goes directly to decision block 62, where the house number is checked for service area, as described above. If there is no street-match (“NO” to decision block 66), then the program exits and returns to the main login screen, and indicates login-failure.

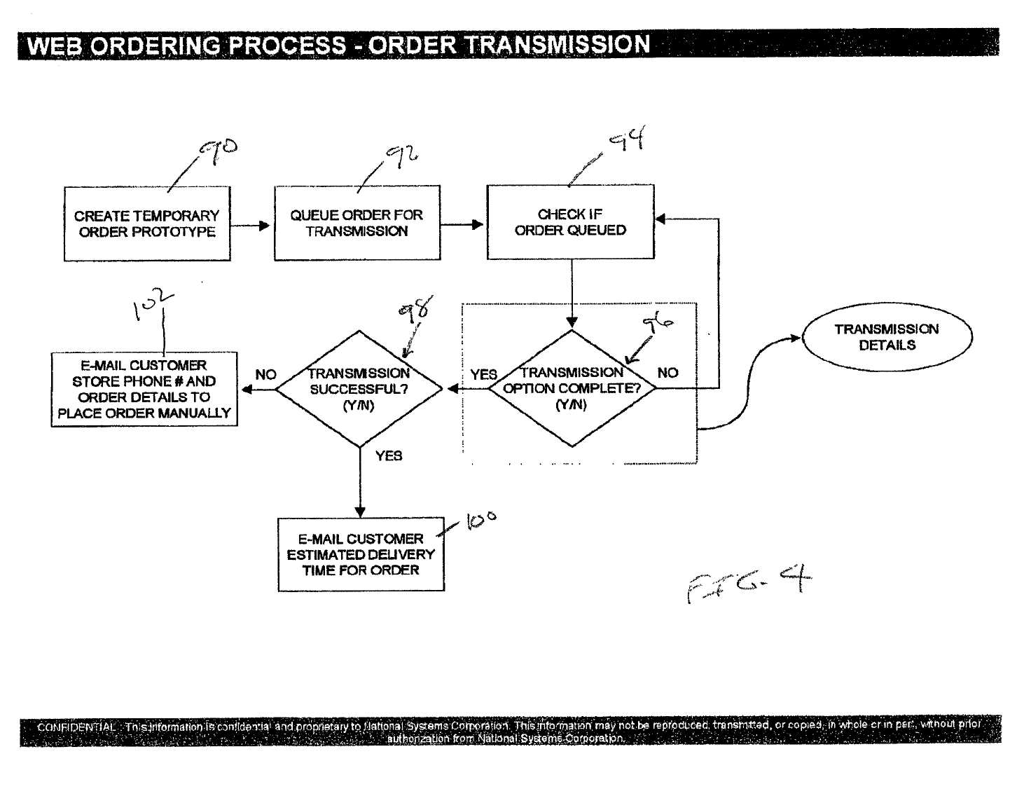

Turning now to FIG. 3, there is shown the web-ordering process flow chart of the software of the invention, which is achieved after successful login by the customer (block 70), as discussed above with reference to FIGS. 1 and 2. The customer, whether a new customer or old one, is prompted to enter his order (block 72). One option to the customer is whether he wishes to reorder his previous order (decision block 74). It “YES”, the previous order is included in the current order (block 76). Then, the program returns to the main order menu again (block 72) for giving the customer the opportunity to add additional items to his current order. If the answer is “NO”, then the program returns to the main menu again (block 72), without adding the previous order to the current order. The customer, also, has the opportunity to order one of the current special offered by the selected store (decision block 78). If “NO”, then the program returns to the main menu (block 72). If “YES”, then the customer selects which one or ones of the specials he wants (block 80), and then returns to the main menu (block 72). The customer is also given the opportunity to add more menu-items to his order (decision block 82). If “YES”, then the program returns to the main menu (block 72) and allows the customer to continue to add additional menu items to his order (decision block 82). When the answer to decision block 82 is finally “NO”, the order is then to be confirmed, and the sofware asks the customer to confirm what he has ordered is correct (block 84). The program then checks to see if the customer's address has been verified by the customer (decision block 86), and, if “YES”, the order is transmitted to the selected store for processing (block 88), as will be discussed hereinbelow with regard to FIG. 4. If the address has not been verified, then the program returns to block 22 of FIG. 1.

Turning to FIG. 4, there is shown the flow chart for transmitting the order received on the Internet server to the local store or restaurant chosen by the software of the invention. The software of the invention first creates a temporary-order prototype listing the items ordered (block 90). Any conventional or standard order format may be employed. Then, the order is queued for transmission (block 92), and then the software of the invention is checked to ensure that the order has been placed in queue (block 94). When the order-queue is checked, it is then determined if the order is to be transmitted in the default manner; that is, transmission of the order is accomplished by a modem-to-modem connection via the Internet between the server's computer and the selected local store's computer, whereby the customer's order is input directly into the computerized ordering system of the local store, thereby bypassing entry via point-of-sale, such as via a human order-taker, and thereby directing the order directly to the order-fillers, such as cook, etc. If, for whatever reason, such Internet modem-to-modem connection is not possible, then back-up methods are used, such as a direct, conventional PSTN-modem-to-modem call-connection, or a direct call over the PSTN to the human order-taker, and by sending a facsimile over the PSTN for action by the human order-taker. In decision block 96, it is determined if the transmission option has been completed, meaning if the order has been sent on to the local store via the default , modem-to-modem transmission. If “NO”, meaning that the default modem-to-modem connection has not been established, the program returns to block 94 to establish a secondary or back-up mode, such as discussed above. If the answer to decision block 96 is “YES”, then the program determines if the chosen transmission has been successful (block 98). If “YES”, then an e-Mail is sent to the customer confirming the successful order-process (block 100). If the answer to decision block 98 is “NO”, then an e-Mail is sent to the customer indicating the unsuccessful ordering process, and sending to him the phone number of the local, selected store, along with his order-details, indicating to the customer to manually call the store to place his order (block 102).

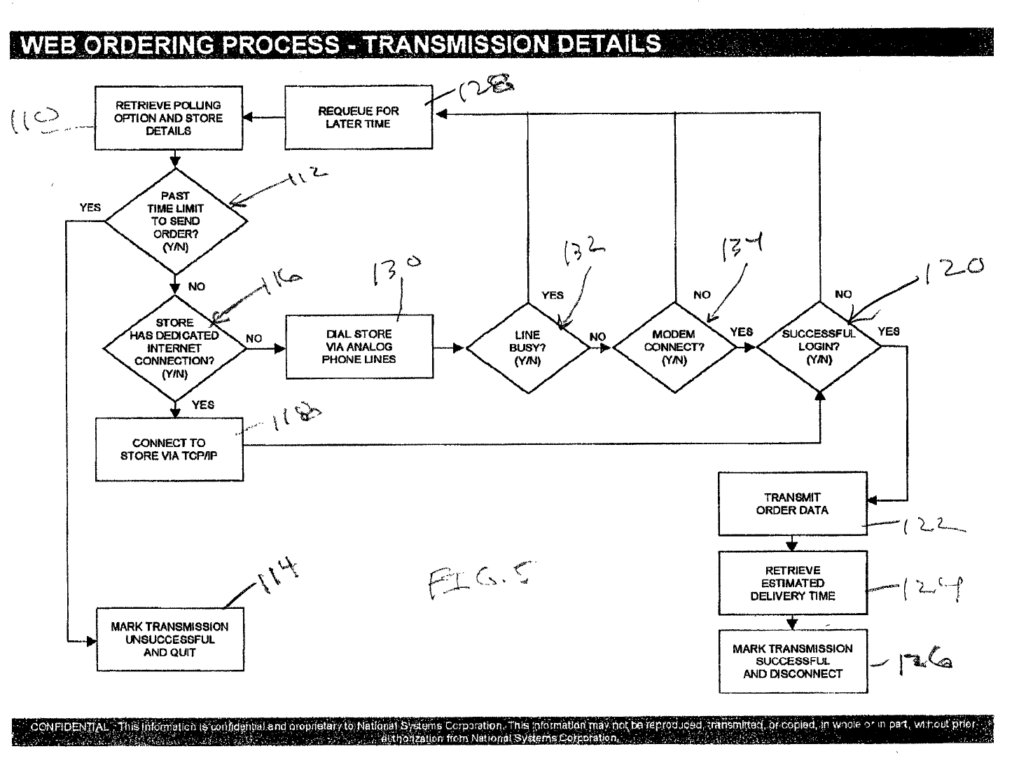

Turning now to FIG. 5, there is shown the flow chart of the transmission-details of the order to the local, selected store. In block 110, the software of the invention at the web site retrieves the necessary information regarding the selected, local store, such as Internet address, the PSTN telephone number for the store's modem, and the PSTN telephone number of the stores call-in, manual order-taking system, depending upon which mode of transmission has been determined in block 94 of FIG. 4, discussed above. After retrieving the necessary store-information for transmitting the order to the local store, the software checks to see if a preset time limit has expired for sending the order (decision block 112). If “YES”, then the transmission has failed, and an error message is generated to the customer and the process is terminated (block 14), and an e-Mail is sent to the customer, as described above with reference to block 102 of FIG. 4. If the answer to decision block 112 is “NO”, then the program determines which way to send the order (decision block 116). The program first determines if the local store has a dedicated Internet connection, and if “YES”, then the order is attempted to be transmitted via the Internet directly into the dedicated order-processing computer of the local store, thereby bypassing manual, human order-taking (block 118). The program checks to see if successful login has been accomplished with the dedicated Internet site of the local store (decision block 120), and if “YES”, then the transmission is carried out and the order o sent (block 122), whereupon the software of the invention retrieves data on the estimated time of delivery (block 124) and other store-relevant information for e-mailing to the customer (block 100 of FIG. 4), and then the transmission is marked as successful, and the connection terminated (block 126). If the answer to decision block 120 is “NO”, then the program will re-queue that order for a later time, in order to retry the connection to the dedicated Internet address of the local store (block 128). The program returns to block 110, for repeating the order-transmission. If during the next attempted transmission of that order it is indicated in decision block 112 that the time has expired, then no additional attempts will be made, and the order-transmission for that order will be terminated. If the time-limit has still not been reached when re-trying to send the order, then decision block 116 will again direct the transmission through the Internet, as described above. It is noted that in decision block 116, if after one or more attempts to transmit the order over the Internet have failed, the software of the invention may default to a back-up transmission, as described above, such as a PSTN connection to the manual, order-taker system of the store. In this scenario, having attempted and failed a predetermined one or more times, then the software of the invention in decision block 116 will assume “NO” to the question of a dedicated Internet location of the selected local store. In any case, whenever the answer to decision block 116 is “NO”, then the program will seek to transmit the order via a back-up method using the PSTN analog telephone lines for a connection to the standard, manual order-taking system of the store, manned by personnel (block 130). The software of the invention will look for a busy-signal detection (decision block 132), and if “YES”, will be re-queued for a later time (block 128). If “NO”, then the software awaits for a modem-connection (decision block 134), if the back-up transmission is by means of a modem-to-modem direct connection via the PSTN. If the modem connection has not been detected (“NO” to decision block 134), then the order is re-queued to subsequent, later time (block 128). If the modem-connection has been detected (“YES” to decision block 134), then decision block 120 will determine if there has been successful login to the store's dedicated order-taking computer, as described above when discussing block 120.

While in the preferred embodiment, the invention has been disclosed for use with a chain of pizza stores, it is to be understood that other types of stores and restaurants may be accommodated, and that numerous changes and modifications may be made therein without departing from the scope and spirit of the invention as set forth in the appended claims.

What we claim is:

1. A method of receiving and placing an order on the Internet to a selected store of a chain of stores, comprising:
(a) storing at an Internet web site at least a partial list of stores of a chain of stores, and their postal addresses, where each store of the at least a partial list of stores services customers in a specific geographical area;
(b) storing at said Internet web site a postal-service listing of customers potentially serviced by said at least a partial list of stores;
(c) creating the potentiality of establishing a point-to-point connection between the computer associated with said Internet web site with the associated computer of each of said at least a partial list of stores;
(d) receiving a request to order at said Internet web site from a customer;
(e) determining at said web site which store of said at least a partial list of stores services the customer of said step (d)
(f) receiving the order from the customer of said step (d);
(g) downloading the order received in said step (f) to the selected store from said step (e);
(h) said step (g) comprising downloading the order directly into the computer system of the selected store, thereby bypassing the order-taking process of the selected store.

2. The method of receiving and placing an order on the Internet to a selected store of a chain of stores, according to claim 1, further comprising:
(i) uploading from the computer of the selected store of said step (e) the menu of that selected store; said step
(i) being performed after said step (e).

3. The method of receiving and placing an order on the Internet to a selected store of a chain of stores, according to claim 1, wherein said step (a) comprises storing said at least a partial list of stores by postal-service zip code.

4. The method of receiving and placing an order on the Internet to a selected store of a chain of stores, according to claim 1, wherein said step (b) comprises storing said customer listing by street address.

5. The method of receiving and placing an order on the Internet to a selected store of a chain of stores, according to claim 4, wherein said step (a) comprises storing the service-map of each store of said at least a partial list of stores, which service-map lists the boundaries of service of each said store by street address; said step (e) comprising matching the street address of the customer of said step (d) with the street adress of a selected one of said at least a partial list of stores.

6. The method of receiving and placing an order on the Internet to a selected store of a chain of stores, according to claim 5, wherein said step (e) comprises comparing the street address of the customer of said step (d) with the street addresses of a plurality of chosen stores of said at least a partial list of stores in order to determine which selected one of the plurality of chosen stores specifically services the customer address of said step (d).

7. The method of receiving and placing an order on the Internet to a selected store of a chain of stores, according to claim 1, wherein said step (c) comprises using at least one of: The Internet, and direct modem-to-modem connection over the PSTN.

8. The method of receiving and placing an order on the Internet to a selected store of a chain of stores, according to claim 1, wherein said step (g) comprises attempting to download the order first via one of the: Internet, and downloading the order through a direct modem-to-modem connection via the PSTN to the selected store's computer.

9. The method of receiving and placing an order on the Internet to a selected store of a chain of stores, according to claim 2, wherein each of said steps (g) and (i) comprises downloading via at least one of the: The Internet, and direct modem-to-modem connection via the PSTN.

10. The method of receiving and placing an order on the Internet to a selected store of a chain of stores, according to claim 1, further comprising:
(i) after said step (h), uploading from the computer of the selected store from said (e) to the computer of the Internet web site the estimated time of delivery of the downloaded order of said step (h); and
(j) e-mailing the customer of said step (d) the estimated time of delivery.

11. The method of receiving and placing an order on the Internet to a selected store of a chain of stores, according to claim 1, further comprising:
(i) e-mailing the customer of said step (d) a message that the selected store of said step (e) cannot fill the order via computer-to-computer connection.

12. The method of receiving and placing an order on the Internet to a selected store of a chain of stores, according to claim 1, further comprising, before said step (e):
(j) uploading from at least one of the stores of said chain of stores the street-address servicing area serviced by said at least one store of said chain of stores; and
(k) storing the street-address servicing area at said Internet web site.

13. The method of receiving and placing an order on the Internet to a selected store of a chain of stores, according to claim 12, wherein said step of uploading from at least one of the stores of said chain of stores the street-address servicing area serviced by each said at least one store of said chain of stores comprises uploading all of the servicing area maps of all of the stores of said chain of stores; and said step of storing the street-address servicing area at said Internet web comprises storing all of the uploaded servicing area maps of all of the stores of the chain of stores, whereby said step (e) may be performed.

14. The method of receiving and placing an order on the Internet to a selected store of a chain of stores, according to claim 1, wherein the order of said step (f) is for at least one pizza, said step (f) comprising:
said customer selecting at least the size of the pizza and the toppings therefor.

15. The method of receiving and placing an order on the Internet to a selected store of a chain of stores, according to claim 1, wherein said step (e) comprises: Normalizing the address entered by the customer using address-normalization software, so that the address is normalized to a certified postal-service address-list.

16. A method of sending an order received on the Internet to a selected store of a chain of stores, comprising:
(a) storing at an Internet web site at least a partial list of stores of a chain of stores with their locations, where each store of the at least a partial list of stores services customers in a specific geographical area;
(b) storing at said Internet web site a postal-service listing of customers potentially serviced by said at least a partial list of stores;
(c) creating the potentiality of establishing a point-to-point connection between the computer associated with said Internet web site with the associated computer of each of said at least a partial list of stores;
(d) determining at said web site which store of said at least a partial list of stores services a customer placing an order;
(e) downloading a customer order to the selected store from said step (d);
(f) said step (g) comprising downloading the order directly into the computer system of the selected store, thereby bypassing the order-taking process of the selected store.

17. The method of sending an order received on the Internet to a selected store of a chain of stores, according to claim 14, further comprising:
(g) uploading from the computer of the selected store of said step (d) the menu of that selected store;
said step (a) comprising storing a list of stores of a chain of pizza stores;
said step (e) comprising downloading the size of the pizza ordered, the toppings therefor, and ancillary order-items.

18. The method of sending an order received on the Internet to a selected store of a chain of stores, according to claim 16, wherein said step (a) comprising storing a list of stores of a chain of restaurants.

19. The method of sending an order received on the Internet to a selected store of a chain of stores, according to claim 16, wherein said step (b) comprises storing said customer listing by street address.

20. The method of sending an order on the Internet to a selected store of a chain of stores, according to claim 19, wherein said step (a) comprises storing the service-map of each store of said at least a partial list of stores, which service-map lists the boundaries of service of each said store by street address; said step (d) comprising matching the street address of the customer with the street address of a selected one of said at least a partial list of stores.

21. The method of sending an order on the Internet to a selected store of a chain of stores, according to claim 19, wherein said step (d) comprises comparing the street address of the customer with the street addresses of a plurality of chosen stores of said at least a partial list of stores in order to determine which selected one of the plurality of chosen stores specifically services the customer address.

22. The method of sending an order on the Internet to a selected store of a chain of stores, according to claim 16, wherein said step (c) comprises using at least one of: The Internet, and direct modem-to-modem connection over the PSTN.

23. The method of sending an order on the Internet to a selected store of a chain of stores, according to claim 16, further comprising after said step (e), if said step (e) fails:
(h) placing an automated computer generated, voice-order to said selected store for inputting the order through the normal, human-operator controlled order-taking service.

24. The method of sending an order on the Internet to a selected store of a chain of stores, according to claim 16, further comprising:
(f) e-mailing the customer a message that the selected store cannot fill the order via computer-to-computer connection.

25. The method of sending an order on the Internet to a selected store of a chain of stores, according to claim 16, wherein said step (d) comprises: Normalizing the address entered by the customer using address-normalization software, so that the address is normalized to a certified postal-service address-list.

26. A system for sending an order received on the Internet to a selected store of a chain of stores, comprising:
a web-site on the Internet, said web site having a dedicated computer means and memory means operatively associated with said computer means, said memory means comprising;
a first section storing at least a partial list of stores of a chain of stores by postal address, where each store of the at least a partial list of stores services customers in a specific geographical area;
a second section storing a postal-service listing of customers potentially serviced by said at least a partial list of stores;
a third section storing applications software for creating the potentiality of establishing a point-to-point connection between the computer associated with said Internet web site with the associated computer of each of said at least a partial list of stores;
a fourth section storing applications software for determining at said web site which store of said at least a partial list of stores services a customer placing an order; and
a fifth section storing applications software for downloading a customer order directly into the computer system of the selected store, thereby bypassing the order-taking process of the selected store.

27. The system for sending an order received on the Internet to a selected store of a chain of stores, according to claim 26, wherein said second section of said memory means comprises means for storing said customer listing by street address.

28. The system of sending an order on the Internet to a selected store of a chain of stores, according to claim 26, wherein said first section comprises means for storing the service-map of each store of said at least a partial list of stores, which service-map lists the boundaries of service of each said store by street address; and said fourth section comprising means for matching the street address of the customer with the street address of a selected one of said at least a partial list of stores.

29. The system of sending an order on the Internet to a selected store of a chain of stores, according to claim 27, wherein said fourth section comprises software application means for comparing the street address of the customer with the street addresses of a plurality of chosen stores of said at least a partial list of stores in order to determine which selected one of the plurality of chosen stores specifically services the customer address.

30. The system of sending an order on the Internet to a selected store of a chain of stores, according to claim 26, wherein said fifth section comprises means for establishing communication with the computer of the selected one of the chain of stores by at least one of: The Internet, and direct modem-to-modem connection over the PSTN.

31. The system of sending an order on the Internet to a selected store of a chain of stores, according to claim 26, wherein said memory means further comprises a sixth section storing normalizing software for normalizing the address entered by the customer, so that the address is normalized to a certified postal-service address-list.
